(19) United States
(12) Patent Application Publication
(10) Pub. No.: US 2008/0014492 A1
(43) Pub. Date: Jan. 17, 2008

(54) Compression assembly, solid oxide fuel cell stack, a process for compression of the solid oxide fuel cell stack and its use

(76) Inventors: Jens Ulrick Nielsen, Soborg (DK); Christian Olsen, Ballerup (DK); Niels Erikstrup, Frederiksberg (DK); Jesper Norsk, Humlebaek (DK)

Correspondence Address: DICKSTEIN SHAPIRO LLP, 1825 EYE STREET NW, Washington, DC, 20006-5403, US

(21) Appl. No.: 11/486,060

(22) Filed: Jul. 14, 2006

(51) Int. Cl. H01M 8/02; H01M 8/12

(52) U.S. Cl. 429/37; 429/32; 429/13

(57) ABSTRACT

Compression assembly for distributing an external compression force to a solid oxide fuel cell stack, the external compression force being exerted on both ends of the solid oxide fuel cell stack, the solid oxide fuel cell stack comprising a plurality of solid oxide fuel cells in electrical series, each end of the solid oxide fuel cell stack being placed adjacent to an end plate surface, wherein the surface of at least one of the end plates opposite to the surface facing the solid oxide fuel cells, is provided with a force distributing layer comprising a rigid frame extending above the region of the sealing area of the solid oxide fuel cell stack and one or more resilient elements placed inside the space enclosed by the frame and positioned above the electrochemically active area of the solid oxide fuel cell stack, and placed on the force distributing layer a force transmitting plate on which the external compression force is exerted. A process for compressing a solid oxide fuel cell stack is also provided.

The invention relates to a process for compression of a fuel cell stack and to a compression system useful particularly in a high temperature fuel cell stack such as a solid oxide fuel cell stack.

### BACKGROUND OF THE INVENTION

A fuel cell is an electrochemical device in which electricity is produced. The fuel, typically hydrogen, is oxidised at a fuel anode and oxygen, typically air, is reduced at a cathode to produce an electric current and form by-product water and heat. The hydrogen can also be derived by internal reforming of a hydrocarbon such as methane in the fuel cell. An electrolyte is required which is in contact with an anode and a cathode and it may be alkaline or acidic, liquid or solid.

In solid oxide fuel cells (SOFC) the electrolyte is a solid, nonporous metal oxide material. SOFC are high temperature fuel cells operating at temperatures of 650-1000° C. They are particularly useful for internal reforming of fuels such as methane.

The use of SOFC in power generation offers potential environmental benefits compared with power generation from sources such as combustion of fossil fuels in internal combustion engines.

A SOFC stack of the planar type is built up of a plurality of flat plate solid oxide fuel cells stacked on top of each other and inserted between two planar end plates consisting of a first end plate adjacent to the first solid oxide fuel cell and a second end plate adjacent to the last solid oxide fuel cell. The solid oxide fuel cells are sealed at their edges by gas seals of typically glass or other brittle materials in order to prevent leakage of gas from the sides of the stack. Situated between each individual solid oxide fuel cell is an interconnect for current collection and gas distribution.

The SOFC stack is mechanically compressed by exerting forces on the two end plates. The end plates can be made of for instance metal. Compression of the end plates is of a sufficient strength to ensure that during operation the gas seals present at the edges of the SOFC cells remain gas tight, electrical contact between the different layers of the SOFC stack is maintained and at the same time of a strength that is low enough to ensure that the electrochemically active components of the SOFC stack are not excessively deformed.

During operation the SOFC stack can be subjected to temperatures of 650° C. to 1000° C. causing temperature gradients in the SOFC stack and thus thermal expansion of the different components of the SOFC stack. The section of the SOFC stack that experiences the largest expansion depends on the operating conditions and can for instance be located in the centre of the stack or at the border of the stack in for instance a corner. The resulting thermal expansion may lead to a reduction in the electrical contact between the different layers in the SOFC stack. The thermal expansion may also lead to cracks and leakage in the gas seals between the different layers, leading to poorer functioning of the SOFC stack and a reduced power output.

Solving this problem by selecting materials with specific deformation properties has proved to be very difficult since the components of the SOFC stack need to have electrical contact at different temperature profiles and at the same time have a reasonable life-span.

Other ways of solving this problem include different approaches to providing compression of the SOFC stack. The use of mechanical springs is well known, see for instance U.S. Pat. No. 7,001,685, in which a spring is used to provide compression on the whole surface of the stack and to absorb the differences in height of two stacks placed in electrical series.

The use of springs for providing compression force on the end plate however have the disadvantage of not allowing the different sections of the fuel cell to expand as dictated by the operating conditions. This causes loss of electrical contact or leakage of the gas seals.

It is an objective of the invention to provide a compression assembly for a solid oxide fuel cell stack in which different compression pressures for different parts of the solid oxide fuel cell stack are simultaneously exerted on the stack.

It is yet an objective of the invention to provide a compression assembly in which the compression pressures for the electrochemically active area and the sealing area of the solid oxide fuel cells are not identical.

Yet another objective of the invention is to provide a solid oxide fuel cell stack in which there is established and maintained good electrical contact within the stack during operation.

### BRIEF DESCRIPTION OF THE INVENTION

The above objectives are achieved by providing a compression assembly for distributing an external compression force to a solid oxide fuel cell stack, the external compression force being exerted on both ends of the solid oxide fuel cell stack, the solid oxide fuel cell stack comprising a plurality of solid oxide fuel cells in electrical series, each end of the solid oxide fuel cell stack being placed adjacent to an end plate surface, wherein the surface of at least one of the end plates opposite to the surface facing the solid oxide fuel cells, is provided with a force distributing layer comprising a rigid frame extending above the region of the sealing area of the solid oxide fuel cell stack and one or more resilient elements placed inside the space enclosed by the frame and positioned above the electrochemically active area of the solid oxide fuel cell stack, and placed on the force distributing layer a force transmitting plate on which the external compression force is exerted.

The objectives are further achieved by providing a process for compressing a solid oxide fuel cell stack comprising at both ends of the stack comprising stacking a plurality of solid oxide fuel cells in electrical series, placing each end of the solid oxide fuel cell stack adjacent to an end plate surface, providing the surface of at least one of the end plates opposite to the surface facing the solid oxide fuel cells with a force distributing layer of flexible elements and a rigid frame above the region of the electrochemically active area and the sealing area of the solid oxide fuel cell stack applying an external force to the force distributing layer, whereby the resulting compression pressure is distributed unequally across the region of the sealing area and the electrochemically active area, and the compression pressure exerted in the region of the sealing area is greater than the compression pressure exerted on the electrochemically active area of the solid oxide fuel cell stack.

According to another aspect of the invention there is provided a solid oxide fuel cell stack comprising the compression assembly and use of the solid oxide fuel cell stack for the generation of power.

### BRIEF DESCRIPTION OF THE DRAWINGS

FIG. 1 shows the different components of a SOFC stack of the invention.

FIG. 2 shows a vertical section of a SOFC stack in another embodiment of the invention.

FIG. 3 shows a vertical section through a SOFC stack in an embodiment of the invention where the resilient element is air.

FIG. 4 shows an embodiment of the invention where the resilient elements are springs.

FIG. 5 shows another embodiment of the invention where the resilient elements are springs.

FIG. 6 shows the distribution of forces in the SOFC stack.

### DETAILED DESCRIPTION OF THE INVENTION

In SOFC many sealing materials require a higher compression pressure to create a gas tight seal than the required compression pressure to create electrical contact on the electrochemically active area. Subjecting the electrochemically active area to compression forces that are too high lead to its deformation. When utilising the compression assembly of the invention the compression forces are separated into several regions so that the electrochemically active area can be compressed with a pressure that is, for instance, smaller than the pressure present in the sealing regions.

This is an advantage because separation of the compression forces makes it possible to choose a suitable compression pressure for the electrochemically active area independent of the compression pressure required in the region of the sealing material.

According to the inventive process, the overall compression force on the fuel cell stack is provided by exerting an external force on force transmitting plates situated at each end of the fuel cell stack. The external force is transmitted through the force transmitting plate and at one or both ends of the fuel cell stack distributed to a force distributing layer comprising a frame extending in the region of the sealing area of the SOFC and one or more resilient elements placed inside the space enclosed by the frame and positioned above the electrochemically active area of the SOFC. Between the force distributing layer and the first solid oxide fuel cell an end plate is placed.

The outer dimensions of the frame, i.e. length and width, are of the same magnitude as those of a single solid oxide fuel cell. In one embodiment the inner dimensions, i.e. inner length and width of the frame, are chosen to provide a surface area covered by the frame corresponding to the sealing area of the solid oxide fuel cell.

The frame is made from a material of greater rigidity than the one or more resilient elements. This is an advantage since it allows the exertion of a greater compression pressure via the frame in the sealing area region compared to the pressure exerted on the electrochemically active area via the one or more resilient elements.

The one or more resilient elements are more flexible than the frame. The force exerted on the force transmitting plate is thereby divided into separate areas with different pressures on the frame and the resilient elements. The flexible material for the one or more resilient elements can be any element that is more flexible than the frame. Examples are materials based on mica or ceramic fibres. Fibrous metallic materials are also suitable. Compressed air or springs of, for instance, metal can also be used.

The one or more resilient elements must cover a surface approximately corresponding to the inner dimensions of the frame. An arbitrary thickness can be chosen since the resilient elements are flexible in nature.

Separating the compression forces in this manner is an advantage as it allows the maintenance of the compression force in situations when temperature gradients cause thermal expansion of the SOFC stack. This allows the SOFC stack to be operated with larger temperature gradients, for instance higher current density, and the stack can be made with a larger number of cells. Higher current density and increased number of cells reduces the overall cost of the SOFC system and increases the power output per stack. SOFC stacks comprising the compression assembly of the invention are therefore particularly suitable for the generation of power.

In an embodiment of the invention the force distributing layer is only situated on the first end plate adjacent to the first solid oxide fuel cell in the stack.

In another embodiment of the invention the force distributing layer is situated on both end plates of the SOFC stack.

In an embodiment of the invention the force distributing layer comprises a frame and one or more resilient elements in the form of metal springs. The metal springs are supported by one or more positioning elements provided with apertures or holes in the region of the electrochemically active area in which the metal springs can be introduced. The metal springs provide compression force separated from both the force transmitted through the one or more spring positioning elements and from the force transmitted through the frame. The spring positioning elements can for instance be one or more plates provided with apertures or holes in the region of the electrochemically active area for positioning the metal springs.

Suitable compression pressures that can be exerted in the region of the electrochemically active area are in the range of 0.05 to 3 bars.

Suitable compression pressures that can be exerted in the region of the cell sealing area are in the range of 0.05 to 40 bars.

These pressures depend on interconnect geometries, sealing materials and fuel cell operating gas pressures.

In a further embodiment of the invention the force distributing layer comprises a frame and a plurality of resilient elements of flexible material.

In another embodiment of the invention the force distributing layer comprises a frame and a plurality of springs. The spring positioning element is in this embodiment not required, when a sufficient number of springs are present. A suitable number of springs are 4 to 100.

In a further embodiment of the invention the force distributing layer comprises a frame and a resilient element of compressed air or a flexible material.

In the following figures different embodiments illustrating the invention are described.

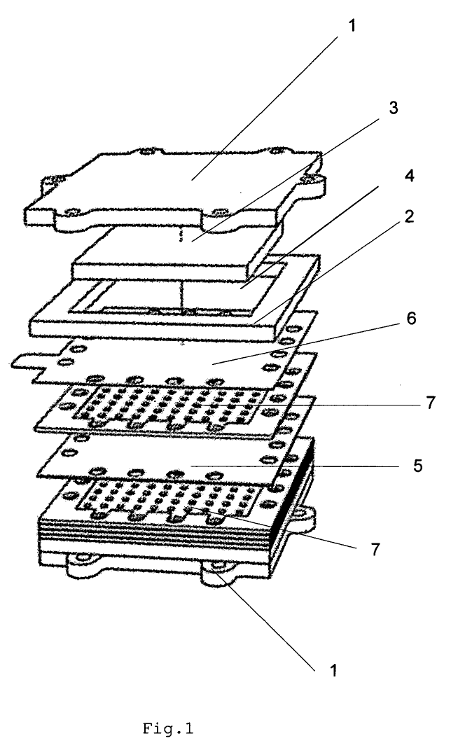

FIG. 1 shows the different components of a SOFC stack according to an embodiment of the invention. External compression force is exerted on force transmitting plate 1. The force is thus transmitted to the force distributing layer comprising frame 2 and one or more resilient elements 3 placed inside the space 4 enclosed by frame 2 and positioned above the electrochemically active area of the solid oxide fuel cell 5. The force distributing layer is followed by planar end plate 6 which in turn is followed by spacer-interconnect assembly 7 and finally by solid oxide fuel cell 5.

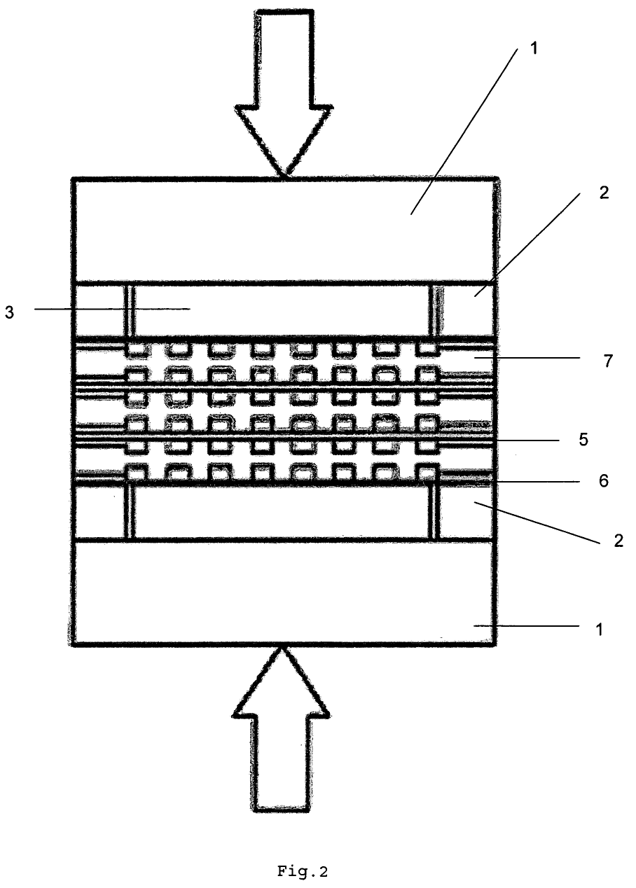

FIG. 2 shows a vertical section through of a SOFC stack according to another embodiment of the invention. The force transmitting plate 1 is subjected to an external compression force which is transmitted to the force distributing layer comprising frame 2 and resilient element 3 and thereby to spacer-interconnect assembly 7 and solid oxide fuel cells 5 placed in electrical series. Each spacer-interconnect assembly 7 has gas channels for transfer of either hydrogen (or another fuel such as methane), oxygen or air to the anode or cathode, respectively.

In this embodiment of the invention two force distributing layers are present. A force distributing layer is placed adjacent to each of the two planar end plates 6. The resilient element 3 can consist of a plurality of elements of flexible material.

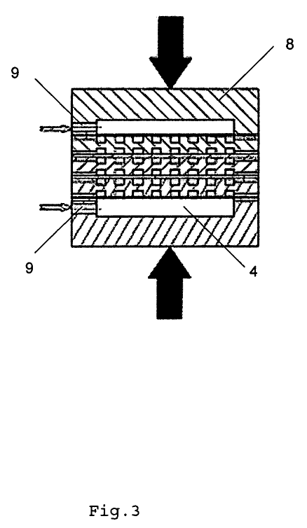

FIG. 3 is a vertical section through a SOFC stack showing a force distributing layer comprising a frame and a resilient element of compressed air. In this embodiment the force transmitting plate and the frame have been integrated to form an integrated frame 8. Inlets 9 for compressed air to the space 4 enclosed by integrated frame 8 are shown. Air pressures of for example 100-1000 mbar gauge can be used.

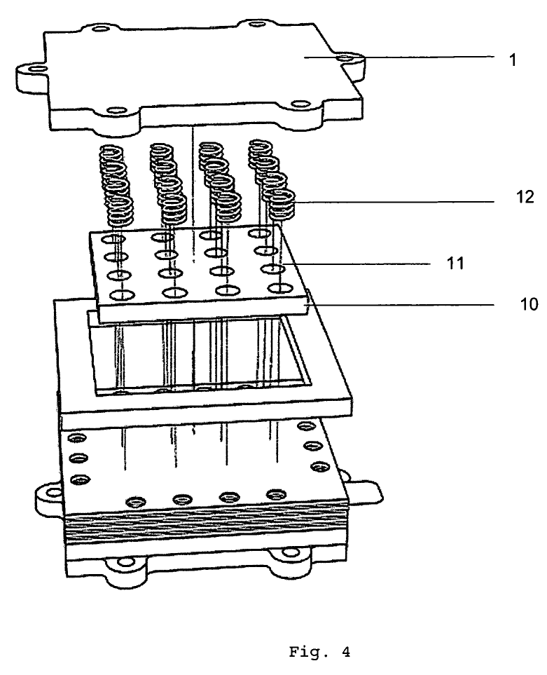

FIG. 4 shows another embodiment of the invention where the force distributing layer comprises a frame and one or more resilient elements in the form of metal springs 12. A spring positioning plate 10 provided with apertures or holes 11 in the region of the electrochemically active area in which the metal springs 12 can be placed. The metal springs 12 provide compression force separated from both the force transmitted through spring positioning plate 10 and from the force transmitted through frame 2.

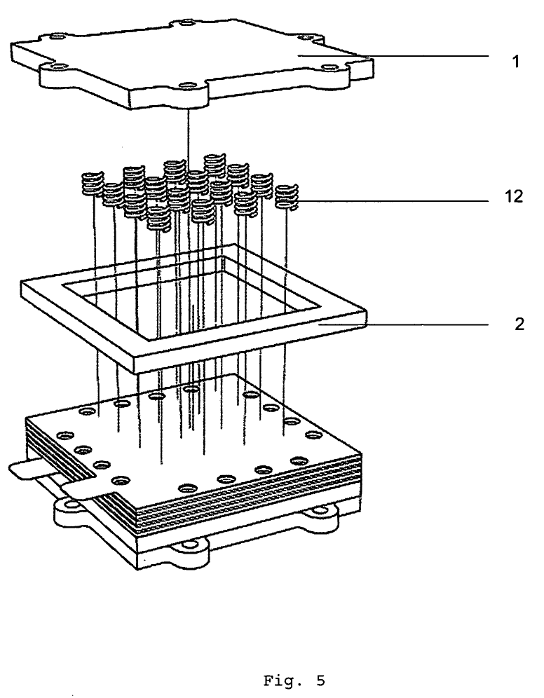

FIG. 5 shows another embodiment of the invention where the force distributing layer comprises a frame 2 and the resilient elements are a plurality of metal springs 12. In this embodiment a spring positioning plate is not required due to the presence of many metal springs supporting each other, for instance in a number between 4 and 100.

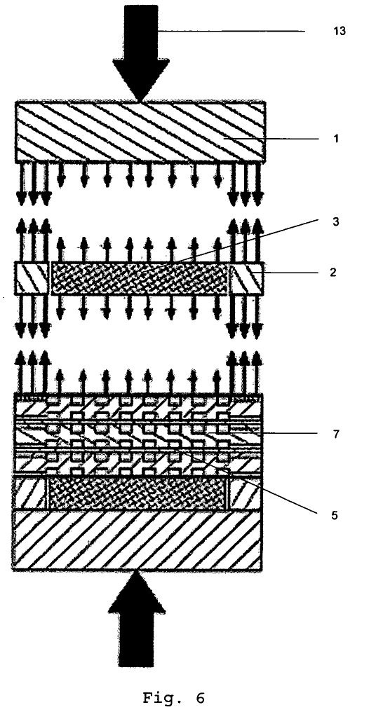

FIG. 6 shows the distribution of forces within the SOFC stack when an external force 13 is exerted on the force transmitting plate 1 thereby providing a compression load to a fuel cell stack. Different compression pressures for different parts of a solid oxide fuel cell stack are simultaneously exerted on the stack. The compression pressures, indicated by arrows, for the electrochemically active area and the sealing area of the solid oxide fuel cell are not equal. The pressure exerted on the resilient element 3 is of a lower magnitude than the pressure exerted on the frame 2, while maintaining good electrical contact within the solid oxide fuel cell stack during operation and at the same time ensuring a gas tight stack.

1. Compression assembly for distributing an external compression force to a solid oxide fuel cell stack, the external compression force being exerted on both ends of the solid oxide fuel cell stack, the solid oxide fuel cell stack comprising a plurality of solid oxide fuel cells in electrical series, each end of the solid oxide fuel cell stack being placed adjacent to an end plate surface, wherein the surface of at least one of the end plates opposite to the surface facing the solid oxide fuel cells, is provided with a force distributing layer comprising a rigid frame extending above the region of the sealing area of the solid oxide fuel cell stack and one or more resilient elements placed inside the space enclosed by the frame and positioned above the electrochemically active area of the solid oxide fuel cell stack, and placed on the force distributing layer a force transmitting plate on which the external compression force is exerted.

2. Compression assembly according to claim 1, wherein the one or more resilient elements are flexible in nature.

3. Compression assembly according to claim 2, wherein the one or more resilient elements are selected from the group of compressed air, a material based on mica, a fibrous ceramic material, a fibrous metallic material and metal springs.

4. Compression assembly according to claim 1, wherein the frame is made of metal.

5. Compression assembly according to claim 1, wherein the frame is integrated with the force transmitting plate.

6. Compression assembly according to claim 3, wherein the one or more resilient elements are arranged in one or more positioning elements provided with holes above the region of the electrochemically active area.

7. Compression assembly according to claim 6, wherein the resilient elements are springs and the positioning element is a spring positioning plate.

8. A solid oxide fuel cell stack comprising a compression assembly according to claim 1.

9. Process for compressing a solid oxide fuel cell stack according to claim 8 at both ends of the stack comprising stacking a plurality of solid oxide fuel cells in electrical series, placing each end of the solid oxide fuel cell stack adjacent to an end plate surface, providing the surface of at least one of the end plates opposite to the surface facing the solid oxide fuel cells with a force distributing layer of flexible elements and a rigid frame above the region of the electrochemically active area and the sealing area of the solid oxide fuel cell stack applying an external force to the force distributing layer, whereby the resulting compression pressure is distributed unequally across the region of the sealing area and the electrochemically active area, and the compression pressure exerted in the region of the sealing area is greater than the compression pressure exerted on the electrochemically active area of the solid oxide fuel cell stack.

10. Use of the solid oxide fuel cell stack according to claim 8 for the generation of power.
